(19) United States
(12) Patent Application Publication
(10) Pub. No.: US 2024/0415180 A1
(43) Pub. Date: Dec. 19, 2024

(54) HEATER AND AEROSOL GENERATING DEVICE INCLUDING THE SAME

(71) Applicant: KT&G CORPORATION, Daejeon (KR)

(72) Inventors: Ju Eon PARK, Seongnam-si (KR); Tae Hun KIM, Yongin-si (KR); Youn Ji SHIN, Seoul (KR); Hun Il LIM, Seoul (KR); Hyung Jin JUNG, Seoul (KR)

(73) Assignee: KT&G CORPORATION, Daejeon (KR)

(21) Appl. No.: 18/611,184

(22) Filed: Mar. 20, 2024

(30) Foreign Application Priority Data
Jun. 16, 2023 (KR) 10-2023-0077517
Aug. 8, 2023 (KR) 10-2023-0103622

(51) Int. Cl. A24F 40/46; A24F 40/10; A24F 40/51

(52) U.S. Cl. CPC A24F 40/46; A24F 40/10; A24F 40/51

(57) ABSTRACT

A heater includes a sheet including a heating region, having of a thin-film shape, and being flexible, a heating body arranged in the heating region and configured to generate heat by receiving power, and an electrode electrically connected to the heating body and configured to supply the power to the heating body, wherein the heating body includes a first heating wire arranged along at least a part of an edge of the heating region and a second heating wire arranged in a region surrounded by the first heating wire.

### CROSS-REFERENCE TO RELATED APPLICATION

This application is based on and claims priority under 35 U.S.C. § 119 to Korean Patent Application No. 10-2023-0077517, filed on Jun. 16, 2023, and Korean Patent Application No. 10-2023-0103622, filed on Aug. 8, 2023, in the Korean Intellectual Property Office, the disclosures of which are incorporated by reference herein in their entireties.

### BACKGROUND

### 1. Field

The present disclosure relates to a heater and an aerosol generating device including the heater, and more specifically, to a heater including an electrical resistance heating body that receives power and generates heat and an aerosol generating device including the heater.

### 2. Description of the Related Art

Recently, the demand for a technology for replacing a method of supplying an aerosol by burning a general cigarette has been increased. For example, research has been conducted on a method of supplying a flavored aerosol by passing a generated vapor after an aerosol is generated from an aerosol generating material in a liquid or solid state or a vapor is generated from an aerosol generating material in a liquid state.

Recently, an aerosol generating device has been proposed, which may generate an aerosol by heating an aerosol generating article as an alternative to the method of supplying an aerosol by burning a cigarette. For example, the aerosol generating device may generate an aerosol by heating an aerosol generating material in a liquid or solid state to a preset temperature by using a heater.

An electrical resistance heater may be used as a heater for electrically heating an aerosol generating material. The electrical resistance heater includes an electrical resistance heating body and may cause generation of an aerosol by heating an aerosol generating material as an electric current flows therethrough.

### SUMMARY

An electrical resistance heater includes an electroconductive heating wire and may be heated as a current flows through the heating wire. However, a resistive heater including a heating wire have a problem in that power consumption efficiency and heat generation efficiency are reduced due to overheating and the durability of the resistive heater is not sufficient.

An object to be achieved by various embodiments of the present disclosure is to provide a heater with excellent power consumption efficiency and heat generation efficiency and an aerosol generating device including the heater.

Another object to be achieved by various embodiments of the present disclosure is to provide a heater that prevents overheating and has increased durability, and an aerosol generating device including the heater.

Objects to be achieved by the embodiments of the present disclosure are not limited to the objects described above, and the objects not described may be clearly understood by those skilled in the art from the present specification and the attached drawings.

Additional aspects will be set forth in part in the description which follows and, in part, will be apparent from the description, or may be learned by practice of the presented embodiments of the disclosure.

According to an aspect of the present disclosure, a heater includes a sheet including a heating region and having of a thin-film shape and flexibility, a heating body arranged in the heating region and configured to generate heat by receiving power, and an electrode electrically connected to the heating body and configured to supply the power to the heating body, wherein the heating body includes a first heating wire arranged along at least a part of an edge of the heating region and a second heating wire arranged in a region surrounded by the first heating wire.

According to another aspect of the present disclosure, an aerosol generating device includes a heater, a power supply configured to supply power to the heater, and a controller configured to control operations of the power supply and the heater.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electroconductive heater according to a first embodiment of the present disclosure;

FIG. 2 is a view illustrating an electroconductive heater according to a second embodiment of the present disclosure;

FIG. 3 is a view illustrating an electroconductive heater according to a third embodiment of the present disclosure;

FIG. 4 is a view illustrating an electroconductive heater according to a fourth embodiment of the present disclosure;

FIG. 5 illustrates experimental data on a heat distribution and highest temperature depending on shapes of heating wires arranged in a heater;

FIG. 6 is a cross-sectional view illustrating an electroconductive heater according to one embodiment of the present disclosure;

FIG. 7 is a configuration diagram illustrating an aerosol generating device according to one embodiment of the present disclosure;

FIG. 8 is a perspective view illustrating a stick heater of the aerosol generating device illustrated in FIG. 7;

FIG. 9 is a configuration diagram illustrating an aerosol generating device according to an embodiment of the present disclosure;

FIG. 10 is a time-temperature graph according to heating of an electroconductive heater according to an embodiment of the present disclosure; and

FIG. 11 is a block diagram of an aerosol generating device according to an embodiment of the present disclosure.

### DETAILED DESCRIPTION

With respect to the terms used to describe the various embodiments, general terms which are currently and widely used are selected in consideration of functions of structural elements in the various embodiments of the disclosure. However, meanings of the terms can be changed according to intention, a judicial precedence, the appearance of new technology, and the like. In addition, in certain cases, terms which can be arbitrarily selected by the applicant in particular cases. In such a case, the meaning of the terms will be described in detail at the corresponding portion in the description of the disclosure. Therefore, the terms used in the various embodiments of the disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Also, in describing the embodiments disclosed in the present disclosure, when it is determined that detailed descriptions of the related known technologies may obscure the gist of the embodiments disclosed in the present disclosure, the detailed descriptions are omitted. Also, the attached drawings are only for easy understanding of the embodiments disclosed in the present disclosure, and the technical idea disclosed in the present disclosure is not limited by the attached drawings and should be understood to include all changes, equivalents, and substitutes included in the idea and technical scope of the present disclosure.

Terms including ordinal numbers, such as first, second, and so on, may be used to describe various components, but the components are not limited by the terms. The terms described above are used only for the purpose of distinguishing one component from another component.

When a component is described to be “connected” or “coupled” to another component, it should be understood that the component may be directly connected or coupled to another component and may be connected or coupled thereto with other components therebetween. In addition, when it is described that a component is “directly connected” or “directly coupled” to another component, it should be understood that there are no other components therebetween.

Singular expressions include plural expressions unless the context clearly dictates otherwise.

Hereinafter, embodiments of the present disclosure are described in detail with reference to the attached drawings such that those skilled in the art may easily implement the present disclosure. However, the present disclosure may be implemented in many different forms and is not limited to the embodiments described herein.

Identical or similar components are given the same reference numbers regardless of the reference numerals and redundant descriptions thereof are omitted.

An electrical resistance heater includes an electroconductive heating wire and may be heated as a current flows through the heating wire. However, a resistive heater including a heating wire has a problem in that a heater lifespan is insufficient and power efficiency is reduced due to overheating.

The present disclosure provides a heater that may avoid a heat generation bottleneck phenomenon capable of occurring in an electrical resistance heating wire used for an electrical resistance heater and reduce power consumption based on excellent heat generation efficiency, and an aerosol generating device including the heater.

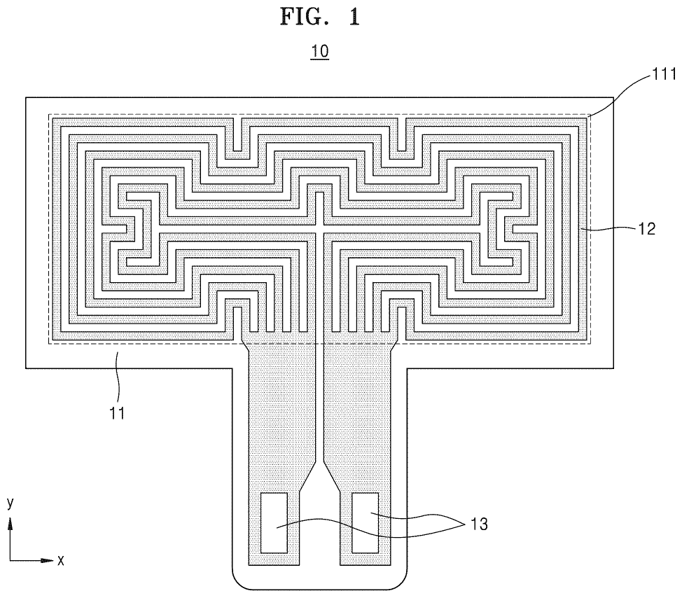

FIG. 1 is a view illustrating an electroconductive heater according to a first embodiment. The electroconductive heater according to the first embodiment is described below with reference to FIG. 1.

According to the first embodiment of the present disclosure, a heater 10 may include a sheet 11 including a flexible material and having a thin-film shape. The sheet 11 may include an electrical insulating material. The sheet 11 may include a thermal conductive material. For example, the thermal conductive material may include ceramics including alumina or zirconia, anodized metal, coated metal, polyimide (PI), and so on but is not limited thereto.

The sheet 11 may be divided into regions. For example, a part of the sheet 11 may be a heating region 111.

The heater 10 may include a heating body 12. The heating body 12 may include an electroconductive resistance, and the heater 10 may be heated as a current flows through the heating body 12. The heating body 12 may generate heat by receiving power. The heating body 12 may be electrically connected to a power supply that supplies power. The heating body 12 may receive power from the power supply. As a current flows through the heating body 12, the temperature of the heater 10 may increase and the temperature of a heated region may increase.

The heating temperature of the heating body 12 may be determined according to the power consumption of the electroconductive resistance of the heating body 12. Also, a resistance value of the heating body 12 may be set based on the power consumption of the electroconductive resistance of the heating body 12. The resistance value of the heating body 12 may be set by a constituent material, a length, a width, a thickness, and a pattern of the heating body 12. according to resistance temperature coefficient characteristics of the heating body 12, internal resistance may increase as the temperature rises. For example, the temperature and resistance of the heating body 12 may be proportional in a preset temperature range.

For example, the heating body 12 may include tungsten, gold, platinum, silver, copper, nickel, palladium, or a combination thereof. Also, the heating body 12 may be doped with an appropriate doping material and may include an alloy.

The heating body 12 may include at least one heating wire. A plurality of heating wires may be arranged separately on both sides of the sheet 11 or may be arranged together on one side. The plurality of heating wires may be arranged in different heating regions of the sheet 11 to heat the sheet 11.

The density of the heating body 12 may be defined by an area occupied by the heating body 12 within the heating region.

The heating body 12 may be electrically connected to a power supply to receive power. Respective heating bodies 12 may independently receive power from a power supply. By independently controlling power for a plurality of heating bodies 12, the power consumption of the plurality of heating bodies 12 may be efficiently controlled.

In general, the electroconductive heating body 12 has a certain lifespan, and a lifespan of the heater 10 may be determined according thereto.

As a current flows through the heating body 12, the temperature of the sheet 11 may increase.

The heating temperature of the heating body 12 may be determined according to the power consumption of resistance of the heating body 12. Also, a resistance value of the heating body 12 may be set based on the power consumption of the resistance of the heating body 12. In this case, the resistance value of the heating body 12 may be set by a constituent material, a length, a width, a thickness, and a pattern of the heating body 12.

The heating body 12 may include an electrical resistance material. For example, the heating body 12 may be made of a metal material. In another example, the heating body 12 may be made of an electroconductive ceramic material, carbon, a metal alloy, or a composite material of a ceramic material and metal.

The heating body 12 may be connected to a printed circuit board (not illustrated) through at least one electrode 13. The heating body 12 may be connected to a power supply (not illustrated) through the one or more electrodes 13 to receive power.

A plurality of heating wires included in the heating body 12 may each be selectively made of the same material group, for example, tungsten, gold, platinum, silver, copper, nickel, palladium, or a combination thereof. For example, the heating body 12 may include an alloy of copper and nickel. The alloy of copper and nickel may be constantan.

At least a part of the heating body 12 may include a pattern region where an extension direction is regularly changed.

The heating body 12 may heat the sheet 11 by generating heat when power is supplied.

The sheet 11 may be a green sheet made of a ceramic composite material. In this case, the ceramic composite material may include a compound of alumina, zirconia, and so on but is not limited thereto.

An extension direction of the heating body 12 of the heater 10 according to the first embodiment of the present disclosure may be changed to be close to a right angle.

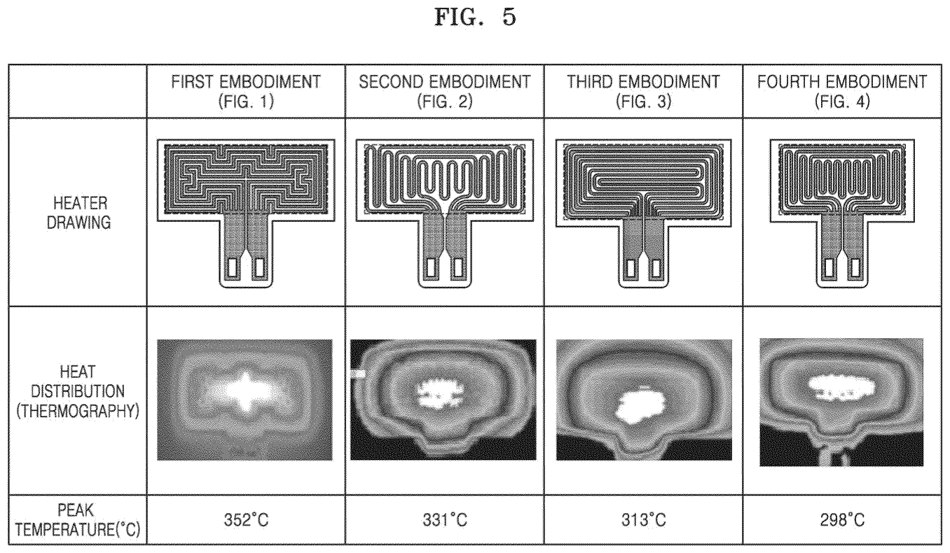

Analysis on a heat distribution and the highest temperature of the heater 10 according to the first embodiment is described below in more detail with reference to FIG. 5 after other embodiments are described below.

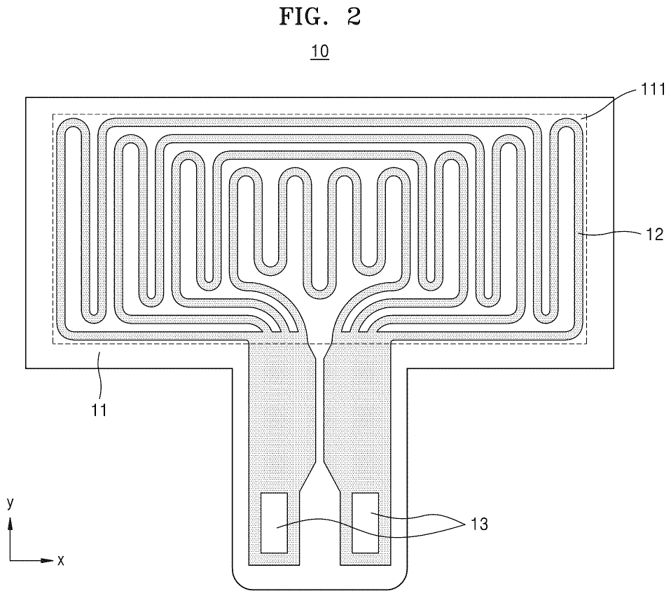

FIG. 2 is a view illustrating an electroconductive heater according to a second embodiment of the present disclosure. The electroconductive heater according to the second embodiment is described below with reference to FIG. 2.

In order to avoid repetitive descriptions, descriptions of the sheet 11, the heating body 12, and the electrode 13 of the heater 10, which overlap the descriptions of the first embodiment made with reference to FIG. 1, may be omitted.

Referring to FIG. 2, the heating body 12 of the heater 10 according to the second embodiment may include a curved region where an extension direction changes to form a preset curvature.

The sheet 11 of the heater 10 according to the second embodiment may have a rectangular shape in which a length in a horizontal direction (a±x direction) is longer than a length in a vertical direction (a±y direction) based on the state illustrated in FIG. 2, and a heating region 111 may also have a rectangular shape in which a horizontal length is longer than a vertical length.

The heating body 12 according to the second embodiment may include a pattern region where an extension direction is regularly changed. Specifically, the heating body 12 may include a pattern region which extends in a direction parallel to a longitudinal length of the heating region 111 and in which an extension direction is periodically changed by 180°. That is, the heating body 12 may include a pattern region where an extension direction changes alternately in the +y direction and −y direction. The pattern region may overlap the curved region. For example, when the extension direction of the heating body 12 changes from the +y direction to the −y direction, the extension direction may change to form a preset curvature.

Analysis on the heat distribution and highest temperature of the heater 10 according to the second embodiment is described below in more detail with reference to FIG. 5 while comparing with other embodiments after the other embodiments are described below.

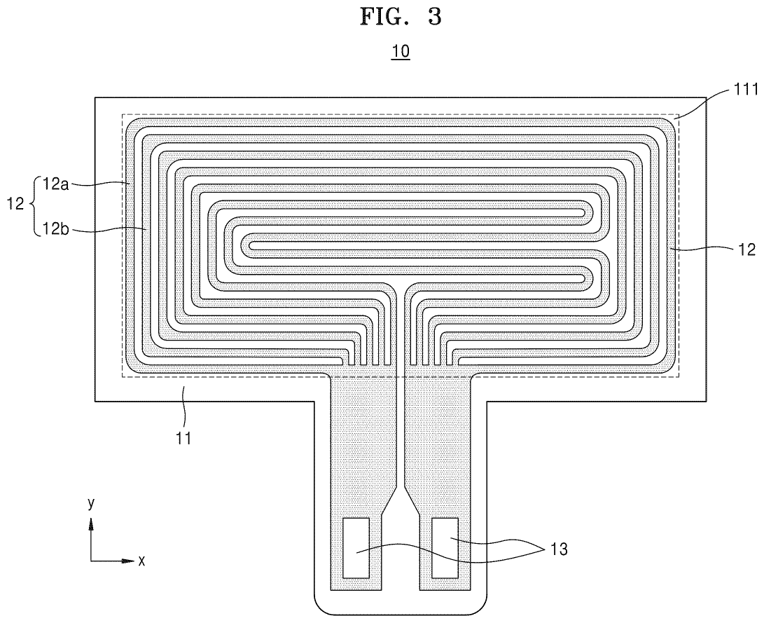

FIG. 3 is a view illustrating an electroconductive heater according to a third embodiment of the present disclosure. The electroconductive heater according to the third embodiment is described below with reference to FIG. 3.

In order to avoid repetitive descriptions, descriptions of a sheet 11, a heating body 12, and an electrode 13 of the heater 10, which overlap the descriptions made with reference to FIGS. 1 and 2, may be omitted.

The heating body 12 may include a first heating wire 12a and a second heating wire 12b.

Like the heating body 12 according to the second embodiment, the heating body 12 according to the third embodiment may include a curved region where an extension direction changes to form a preset curvature. The heating body 12 according to the third embodiment may include the first heating wire 12a arranged along at least a part of an edge of the heating region 111, and a second heating wire 12b in a region surrounded by the first heating wire 12a. Furthermore, the heating body 12 may further include at least one heating wire in a region surrounded by the second heating wire 12b.

Compared to the first or second embodiment, the heating body 12 may include a heating wire having relatively more regions where the heating wire extends straight and having relatively less regions where the heating wire is bent. To this end, the first heating wire 12a of the heating body 12 may be arranged along the edge of the heating region 111. For example, when the heating region 111 is a rectangle as illustrated in FIG. 3, the first heating wire 12a may also extend to form part of the rectangle. In an embodiment in which the heating region 111 is a rectangle, the first heating wire 12a may extend to correspond to a boundary of the rectangle forming the heating region 111.

As in the second embodiment, the heating wire forming the heating body 12 according to the third embodiment may form a curve with a preset curvature when an extension direction is changed. The second heating wire 12b inside the first heating wire 12a may also extend inside the first heating wire 12a to form part of an imaginary rectangle.

The second heating wire 12b inside the first heating wire 12a according to the third embodiment may be similar to the arrangement of the first heating wire 12a. At least a part of the second heating wire 12b may be separated from at least a part of the first heating wire 12a at regular intervals and may extend in the same direction as a direction in which the first heating wire 12a extends.

Specifically, in regions to the left and right of the heating region 111 in which the first heating wire 12a extends in the vertical direction (±y) in FIG. 3, the second heating wire 12b may be separated from the first heating wire 12a at regular intervals and extend in the vertical direction (±y) parallel to the first heating wire 12a. In addition, in a region above the heating region 111 in which the first heating wire 12a extends in the horizontal direction (±x) in FIG. 3, the second heating wire 12b may be separated from the first heating wire 12a at regular intervals and extend in the horizontal direction (±x) parallel to the first heating wire 12a.

The sheet 11 of the heater 10 according to the third embodiment may have a rectangular shape in which a length in the horizontal direction (±x) is longer than a length in the vertical direction (±y), and the heating region 111 may also have a rectangular shape in which a length in the horizontal direction is longer than a length in the vertical direction.

The heating body 12 according to the third embodiment may include a pattern region where an extension direction is regularly changed. Specifically, the second heating wire 12b according to the third embodiment may extend in a direction parallel to the length of the heating region 111 in the horizontal direction (±x) and include a pattern region where an extension direction is periodically changed by 180°. That is, the heating body 12 may include a pattern region where an extension direction alternately changes in the +x direction and −x direction. The pattern region may overlap a curved region. For example, when an extension direction of the heating body 12 changes from the +x direction to the −x direction, the extension direction may change to form a preset curvature.

The heating wires forming the heating body 12 according to the third embodiment may have relatively longer lengths in the horizontal direction (±x) than the lengths of the heating wires in the rectangular heating region 111 in the vertical direction (±y).

Analysis on a heat distribution and highest temperature of the heater 10 according to the third embodiment is described below in more detail with reference to FIG. 5 after other embodiments are described.

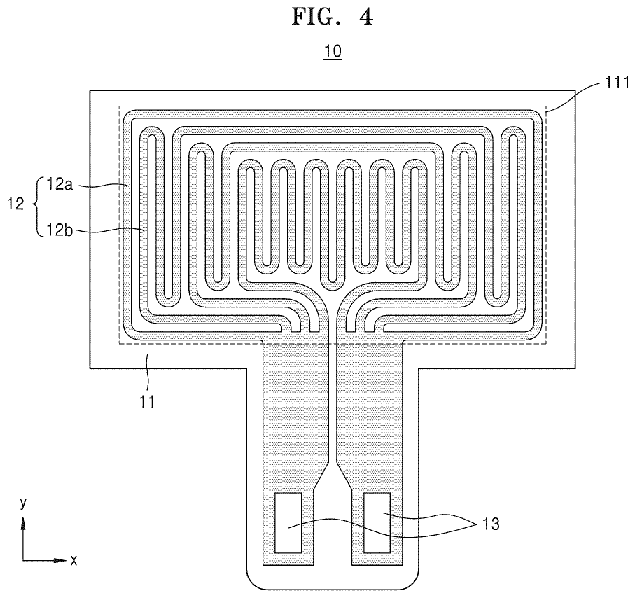

FIG. 4 is a view illustrating an electroconductive heater according to a fourth embodiment of the present disclosure. The electroconductive heater according to the fourth embodiment is described below with reference to FIG. 4.

In order to avoid repetitive description, descriptions of a sheet 11, a heating body 12, and an electrode 13 of the heater 10, which overlap the descriptions of the fourth embodiment made with reference to FIG. 4, may be omitted.

As in the third embodiment, the heating body 12 according to the fourth embodiment may also include a first heating wire 12a arranged along at least a part of an edge of the heating region 111, and a second heating wire 12b in a region surrounded by the first heating wire 12a. Furthermore, the heating body 12 may further include at least one heating wire in a region surrounded by the second heating wire 12b.

The heating body 12 according to the fourth embodiment may include the first heating wire 12a arranged along at least a part of the edge of the heating region 111 to reduce heat concentration. The first heating wire 12a of the heating body 12 according to the fourth embodiment may be arranged along the edge of the heating region 111.

For example, when the heating region 111 is a rectangle, the first heating wire 12a may also extend to form part of the rectangle. When the heating region 111 is a rectangle, the first heating wire 12a may extend to correspond to a boundary of the rectangle forming the heating region 111.

In another example, even when the heating region 111 is a polygon other than a rectangle, the first heating wire 12a may extend to form part of the polygon. When the heating region 111 is a polygon, the first heating wire 12a may extend to correspond to the boundary of the polygon forming the heating region 111.

In another example, when the heating region 111 is an ellipse, the first heating wire 12a may also extend to form part of the ellipse. When the heating region 111 is an ellipse, the first heating wire 12a may extend to correspond to a boundary of the ellipse forming the heating region 111.

At least a part of the second heating wire 12b inside the first heating wire 12a according to the fourth embodiment may be similar to the arrangement of the first heating wire 12a. At least a part of the second heating wire 12b may be separated from at least a part of the first heating wire 12a at regular intervals and may extend in the same direction as a direction in which the first heating wire 12a extends.

Specifically, referring to FIG. 4, in regions to the left and right of the heating region 111 in which the first heating wire 12a extends in the vertical direction (±y), a part of the second heating wire 12b may be separated from the first heating wire 12a at regular intervals and extend in the vertical direction (±y) to be parallel to the first heating wire 12a. However, the arrangement of the first heating wire 12a and the second heating wire 12b is not limited thereto.

As in the second and third embodiments, the heating body 12 according to the fourth embodiment may form a curved region with a preset curvature when an extension direction is changed.

Referring to FIG. 4, the second heating wire 12b inside the first heating wire 12a according to the fourth embodiment may be similar to the arrangement of the heating body 12 according to the second embodiment (see FIG. 2).

The sheet 11 of the heater 10 according to the fourth embodiment may have a rectangular shape in which a length in the horizontal direction (±x) is longer than a length in the vertical direction (±y), and the heating region 111 may also have a rectangular shape in which a length in the horizontal direction is longer than a length in the vertical direction.

The heating body 12 according to the fourth embodiment may include a pattern region where an extension direction is regularly changed. Specifically, the second heating wire 12b according to the fourth embodiment may extend in a direction parallel to the length of the heating region 111 in the vertical direction (±y) and may have a pattern region where an extension direction is periodically changed by 180°. That is, the heating body 12 may include a pattern region where an extension direction changes alternately in the +y direction and −y direction.

The second heating wire 12b according to the fourth embodiment may also include a simple straight line region in addition to the pattern region.

The pattern region may overlap a curved region. For example, when an extension direction of the heating body 12 changes from the +y direction to the −y direction, the extension direction may change to form a preset curvature. In this respect, the second heating wire according to the fourth embodiment differs from the second heating wire according to the third embodiment. The fourth embodiment may be an intermediate form between the second embodiment and the third embodiment.

FIG. 5 illustrates experimental data on a heat distribution (thermography) and highest temperature (° C.) depending on shapes of heating wires arranged in a heater. Hereinafter, it is described with reference to FIG. 5 based on experimental results that the heating efficiency of an electroconductive heater according to various embodiments of the present disclosure may be increased.

A thermography in FIG. 5 is a photo obtained by visualizing infrared rays emitted from a subject by using a thermal imaging camera capable of detecting infrared rays. A heat distribution (thermography) of a table indicates a relative temperature. Specifically, as the temperature increases, the heat distribution (thermography) is expressed in the order of purple (the lowest temperature), blue, sky blue, green, yellow, orange, red, and white (the highest temperature). That is, in the heat distribution (thermography), purple and blue represent regions with relatively low temperatures, and red and white represent regions with relatively high temperatures. The highest temperature refers to the temperature at a point with the highest temperature in the white region of the heat distribution (thermography).

The heat distribution and highest temperature of a heating body according to the shape of each embodiment described with reference to FIGS. 1 to 4 may be seen from FIG. 5. The shape of the heating body according to the first embodiment of FIG. 5 is the shape of the heating body according to the embodiment described above with reference to FIG. 1, and the shape of the heating body according to the second embodiment is the shape of the heating body according to the embodiment described above with reference to FIG. 2, the shape of the heating body according to the third embodiment is the shape of the heating body according to the embodiment described above with reference to FIG. 3, and the shape of the heating body according to the fourth embodiment is the shape of the heating body according to the embodiment described above with reference to FIG. 4.

A heater may include a flexible sheet that has a thin-film shape and includes a heating region. A heating body that receives power and generates heat may be in the heating region of the sheet. The heating body may have a uniform shape. The heating body may include at least one heating wire, and the at least one heating wire may have a uniform shape.

In order to avoid redundant description below, the description on the heater of each embodiment may be replaced with the description of the heater according to the embodiment described above with reference to FIGS. 1 to 4.

In measuring the heat distribution and highest temperature of each embodiment, all conditions other than the shape of the heating body are the same. That is, conditions, such as a material of a heating body in each embodiment, a size of a current applied to the heating body, a resistance value of the heating body, the time for which the current is applied to the heating body, a region of a sheet, and a thickness of the sheet are the same in all embodiments.

Hereinafter, a heat distribution (thermography) and the highest temperature (° C.) of each example of FIG. 5 are described. The highest temperature (° C.) is the temperature of a white region of the heat distribution (thermography). In the heat distribution of FIG. 5, a region, in which the temperature exceeds approximately 300° C., is displayed as a white region.

According to the heat distribution of an experimental result of the first embodiment, the heating body according to the shape of the first embodiment generates the most heat concentration in a central portion of the heating body, and the highest temperature reaches 352° C. That is, it can be seen that the temperature is higher toward the central portion.

Heat is generated in response to the shape of the heating body in other regions, but it can be seen that a lot of heat is generated especially in a region where an extension direction of the heating body changes, that is, a region where the heating body is bent. This is because when the heating body is bent, the heating body does not form a curve and suddenly changes in direction to form a shape close to a right angle, and accordingly, it can be seen that an electronic bottleneck and thermal bottleneck phenomenon of the heating body occurs at a region where the heating body is bent, resulting in overheating.

In particular, the heating body according to the first embodiment has four regions where the heating body is bent at a right angle in a central region of a + shape, and it can be seen that heat concentration is severe in the central region of a + shape of the heat distribution.

Referring to the heat distribution and highest temperature of the first embodiment, it can be seen that relatively more heat is generated in the central region where an extension direction of the heating body changes and relatively less heat is generated in a region where an extension direction of the heating body does not change and continues in a straight line. Therefore, it can be seen that the closer the heating body is to a right angle, the more excessive heat concentration occurs due to an electronic bottleneck and thermal bottleneck and a possibility of overheating increases.

Also, it can be seen that the heating body according to the first embodiment has a relatively narrow gap between heating wires that are on the left and right sides and extend up and down and has a small white region indicating heat concentration in the center of the left and right sides of the heat distribution. Therethrough, it can be seen that even in a straight region where an extension direction of the heating body does not change, the narrower the gap between the heating wires forming the heating body, the more the excessive heat concentration occurs.

According to the heat distribution of an experimental result of the second embodiment, it can be seen that heat concentration in a central portion of the heating body according to the shape of the second embodiment occurs relatively more than in other regions as in the first embodiment. However, it can be seen that a white region where heat concentration occurs in the heating body according to the second embodiment is wider than the white region of the heating body according to the first embodiment, and the highest temperature reaches 331° C. which is lower than the temperature of the first example.

The heating body according to the second embodiment may include a curved region where an extension direction changes to form a preset curvature. Referring to the heat distribution and highest temperature of the second embodiment, when an extension direction of the heating body has a curvature, that is, when the heating body has a curved shape, a heat concentration region due to an electronic bottleneck and thermal bottleneck phenomenon is increased, resulting in a decrease of heat concentration, and the highest temperature may be lowered, and overheating may be prevented.

The sheet of the heater according to the second embodiment has a rectangular shape with a horizontal length longer than a vertical length, and the heating region also has a rectangular shape with a horizontal length longer than the vertical length. The heating body according to the second embodiment may include a pattern region where an extension direction is regularly changed. Specifically, the heating body according to the second embodiment may include a pattern region which extends in a direction parallel to a vertical length of the heating region and in which an extension direction is periodically changed by 180°.

Resistance values of the heating bodies according to the first and second embodiments are equal to each other, voltages applied to the heating bodies are equal to each other, currents flowing through the heating bodies are also equal to each other, and the total heat generation amount of the heating bodies are also equal to each other. Nevertheless, the highest temperature of the heating body according to the second embodiment is reduced by approximately 20° C. compared to the heating body according to the first embodiment. That is, the heating body according to the second embodiment may provide the same heating performance as the heating body according to the first embodiment and has a more even heat distribution than the heating body according to the first embodiment.

According to the heat distribution of the experimental result of the third embodiment, it can be seen that the heating body according to the shape of the second embodiment generates the most heat concentration in a central portion of the heating body as in the first and second embodiments. However, in the heating body according to the shape of the third embodiment, a white region where heat concentration occurs is wider than a white region of the heating body according to the second embodiment, and the highest temperature is 313° C. which is lower than the highest temperature of not only the first embodiment but also the second embodiment. According to the experimental result of the third embodiment, as heat concentration occurs in a wider region, the highest temperature may decrease.

The heating body according to the third embodiment includes a curved region where an extension direction changes to form a preset curvature like the heating body according to the second embodiment. As described above with reference to FIG. 3, the heating body according to the third embodiment may include a first heating wire arranged along at least a part of an edge of a heating region and a second heating wire in a region surrounded by the first heating wire. Furthermore, the heating body may further include at least one heating wire in a region surrounded by the second heating wire.

Compared to the first or second embodiment, the heating body according to the third embodiment may include a heating wire having relatively more regions where the heating wire extends straight and having relatively less regions where the heating wire is bent. To this end, the first heating wire of the heating body according to the third embodiment is arranged along an edge of a heating region. When the heating region is a rectangle as in the third embodiment, the first heating wire also extends to form part of the rectangle. In an embodiment where the heating region is a rectangle, the first heating wire may extend to correspond to a boundary of the rectangle forming the heating region. As in the second embodiment, the heating wire forming the heating body according to the third embodiment has a curve with a preset curvature when an extension direction changes. The second heating wire inside the first heating wire also extends inside the first heating wire to form part of a rectangle.

An arrangement of the second heating wire inside the first heating wire according to the third embodiment is similar to the arrangement of the first heating wire. The sheet of the heater according to the third embodiment has a rectangular shape with a horizontal length longer than a vertical length, and the heating region also has a rectangular shape with a horizontal length longer than a vertical length. The heating body according to the third embodiment may include a pattern region where an extension direction is regularly changed. Specifically, the second heating wire according to the third embodiment extends in a direction parallel to the horizontal length of the heating region and may include a pattern region where the extension direction is periodically changed by 180°.

In the heating wires forming the heating body according to the third embodiment, a length of a heating wire parallel to the horizontal direction is relatively longer than a length of a heating wire parallel to the vertical direction of a rectangular heating region. Therefore, the third embodiment has a high possibility that heat concentration is formed between the horizontal heating wires. The heating region according to the third embodiment has a longer horizontal length than the vertical length, and a proportion of straight heating wire parallel to a long horizontal direction is large, and accordingly, an extension direction of the heating wire may change to relatively reduce an electronic bottleneck and heat generation bottleneck and prevent overheating.

As the heating body according to the third embodiment has the shape described above, it can be seen that the highest temperature of the heat concentration region is greatly reduced to 313° C.

Furthermore, referring to the heat distribution, a white region, which is a heat concentration region caused by the heating body according to the third embodiment, is formed to be wider than a white region in the first or second embodiment.

Resistance values of the heating bodies according to the first, second, and third embodiments are equal to each other, voltages applied to the heating bodies are equal to each other, currents flowing through the heating bodies are also equal to each other, and the total heat generation amount of the heating bodies are also equal to each other. Nevertheless, the highest temperature of the heating body according to the third embodiment is reduced by approximately 20° C. compared to the heating body according to the second embodiment. That is, the heating body according to the third embodiment may provide the same heating performance as the heating bodies of the first and second embodiments and may have the highest temperature that is lower than the highest temperatures of the heating bodies according to the first and second embodiments and have less heat concentration than the heating bodies according to the first and second embodiments.

In summary, the heating body according to the third embodiment has the same total heat generation amount as the heating body according to the first or second embodiment but has a wider region of heat concentration and reduced heat concentration, and accordingly, the highest temperature may be lowered.

In addition, according to the heat distribution of the heating body according to the third embodiment, it can be seen that a region indicated in orange is wider than the region of the first or second embodiment. The heat distribution of the heating body according to the third embodiment means that not only the highest temperature at a central portion is lowered but also the temperature of an edge region where the heating wire is straight is also lowered.

According to an experimental result of the fourth embodiment, the heating body according to the shape of the fourth embodiment has the highest temperature of 298° C., which is lower than the highest temperature of the third embodiment.

As in the third embodiment, the heating body according to the fourth embodiment may also include a first heating wire arranged along at least a part of an edge of the heating region and a second heating wire in a region surrounded by the first heating wire. Furthermore, the heating body may further include at least one heating wire in a region surrounded by the second heating wire.

The first heating wire of the heating body according to the fourth embodiment is arranged along an edge of the heating region as in the third embodiment. When the heating region is a rectangle as in the third embodiment, the first heating wire also extends to form part of the rectangle.

The heating body according to the fourth embodiment may include the first heating wire arranged along at least a part of the edge of the heating region to reduce heat concentration. In an embodiment in which the heating region is a rectangle, the first heating line may extend to correspond to a boundary of the rectangle forming the heating region.

As in the second and third embodiments, the heating wire according to the fourth embodiment forms a curved region with a preset curvature when an extension direction changes.

An arrangement of the second heating wire inside the first heating wire according to the fourth embodiment may be similar to the arrangement of the heating wire of the heating body according to the second embodiment. The sheet of the heater according to the fourth embodiment has a rectangular shape with a horizontal length longer than a vertical length, and the heating region also has a rectangular shape with a horizontal length longer than a vertical length. The heating body according to the fourth embodiment may include a pattern region where an extension direction is regularly changed. Specifically, the second heating wire according to the fourth embodiment extends in a direction parallel to the horizontal length of the heating region and may include a pattern region where the extension direction is periodically changed by 180°. In this respect, the second heating wire according to the fourth embodiment differs from the second heating wire according to the third embodiment. The fourth embodiment may be an intermediate form between the second embodiment and the third embodiment.

In summary, the heating body according to the fourth embodiment has the same total heat generation amount as the heating body according to the first, second, or third embodiment but has a wider region of heat concentration and reduced heat concentration, and accordingly, the highest temperature may be lowered.

In addition, according to the heat distribution of the heating body according to the fourth embodiment, it can be seen that a region indicated in orange is narrower than in the third embodiment and a region indicated in red is relatively wider than in the third embodiment. The heat distribution of the heating body according to the fourth embodiment means that the highest temperature of a central portion where a pattern extending in the vertical direction is formed is lowered, and the temperature of the entire heating portion is appropriately maintained as necessary for heating. That is, according to the fourth embodiment, the highest temperature of the central portion may be lowered while sufficiently maintaining the heating performance in an edge region, and the heat generation temperature of the entire region may be appropriately distributed, compared to the third embodiment.

When summarizing the first, second, third, and fourth embodiments of FIG. 5, under all the same conditions except for a shape of a heating body, the heating body according to the shape of the first embodiment has the narrowest heat concentration region and the highest peak temperature, and the heating body according to the shape of the fourth embodiment has a relatively wide heat concentration region and the lowest peak temperature compared to other embodiments, but the heat generation temperature may be appropriately distributed.

In addition, it is described that the heating bodies according to the second, third, and fourth embodiments have a preset curvature in all regions where an extension direction changes, but the heating bodies according to the embodiments of the present disclosure are not limited to the shapes. According to the present disclosure, a case in which some regions where an extension direction of a heating body changes as needed have a preset curvature and the extension direction of the heating body close to a right angle changes in the other regions may also be included in the protection scope of the present disclosure.

For example, some regions of the heating body arranged in a region where excessive heat concentration occurs may have a curved shape that extends to form a curvature, and conversely, the necessary heat generation may be secured by changing an extension direction to a right angle in some regions of the heating body arranged in a region where heating is insufficient may have an extension direction, and such design may be achieved through experimentation. A design method of the heating body described above may also be included in the protection scope of the present disclosure.

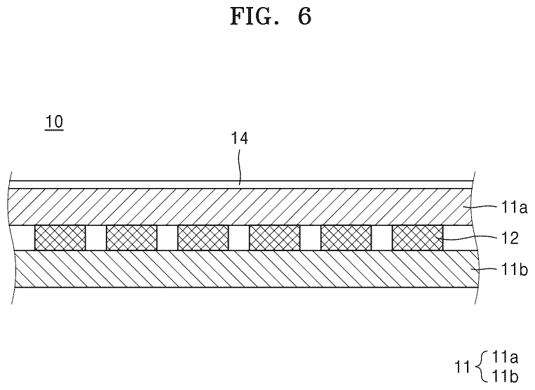

FIG. 6 is a cross-sectional view illustrating an electroconductive heater according to one embodiment of the present disclosure. The electroconductive heater according to one embodiment is described below with reference to FIG. 6.

A sheet 11 may include a structure in which two components are stacked. For example, the sheet 11 may include a structure in which a first sheet 11a of a thin-film shape and a second sheet 11b are stacked.

A heater 10 may include a heating body 12. The heating body 12 may be inside the sheet 11. The heater 10 may include a structure in which the first sheet 11a, the heating body 12, and the second sheet 11b are stacked. For example, the heating body 12 may be in a space between the first sheet 11a and the second sheet 11b of the sheet 11, but the arrangement of the heating body 12 and the sheet 11 is limited thereto.

The sheet 11 may protect the heating body 12 inside the sheet 11 from external shock. The sheet 11 may be coated with glaze to increase durability. For example, a coating layer 14 may be formed on at least a part of the sheet 11.

The coating layer 14 may include a heat-resistant composition. For example, the coating layer 14 may include a single coating layer, such as a glass film coating layer, a Teflon coating layer, and a thermolon coating layer but is not limited thereto. Also, the coating layer 14 may include a composite coating layer composed of a combination of two or more of the glass film coating layer, the Teflon coating layer, and the thermolon coating layer but is not limited thereto.

The coating layer 14 may increase the durability and rigidity of the sheet 11. As the coating layer 14 is provided, a stepped surface formed by a stacked structure including the first sheet 11a, the heating body 12, and the second sheet 11b may be planarized.

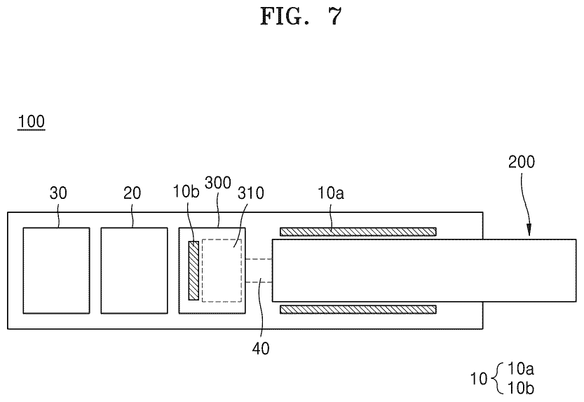

FIG. 7 is a configuration diagram illustrating an aerosol generating device according to one embodiment of the present disclosure. The aerosol generating device according to one embodiment is described below with reference to FIG. 7.

An aerosol generating device 100 may include a heater 10, a power supply 20, and a controller 30. The heater 10 may be the heater 10 described above with reference to FIGS. 1 to 5 but is not limited thereto. The power supply 20 may supply power to components of the aerosol generating device 100, such as the heater 10. The controller 30 may control operations of components of the aerosol generating device 100, such as the heater 10 and the power supply 20.

An aerosol generating article 200 may be detachably coupled to the aerosol generating device 100. The aerosol generating article 200 may include an aerosol generating material, and when the aerosol generating material is heated by the heater 10, an aerosol may be generated.

The heater 10 may be electrically connected to the power supply 20. The heater 10 may receive power from the power supply 20. As a current flows through the heater 10, the temperature of the aerosol generating article 200 may increase, and accordingly, an aerosol may be generated. The heater 10 for heating the aerosol generating article 200 may be referred to as a stick heater 10a.

A cartridge 300 may be detachably coupled to the aerosol generating device 100. The cartridge 300 may include an aerosol generating material. The aerosol generating material may be stored in a storage tank 310. The heater 10 may have a structure for heating the aerosol generating material included in the cartridge 300. The heater 10 for heating the cartridge 300 may be referred to as a cartridge heater 10b.

The aerosol generating material included in the cartridge 300 may be a liquid. The aerosol generating material included in the cartridge 300 may be absorbed by a liquid delivery member (not illustrated) and heated by the cartridge heater 10b. The liquid delivery member may include a wick, such as cotton fiber, ceramic fiber, glass fiber, or porous ceramic.

A cartridge heater 10b may be formed in a coil-shaped structure for winding around the liquid delivery member or a structure for being in contact with one side of the liquid delivery member. When the liquid delivery member is heated by the cartridge heater 10b, an aerosol may be generated. Specifically, a sheet of the cartridge heater 10b may be in contact with at least a part of an outer surface of the liquid delivery member.

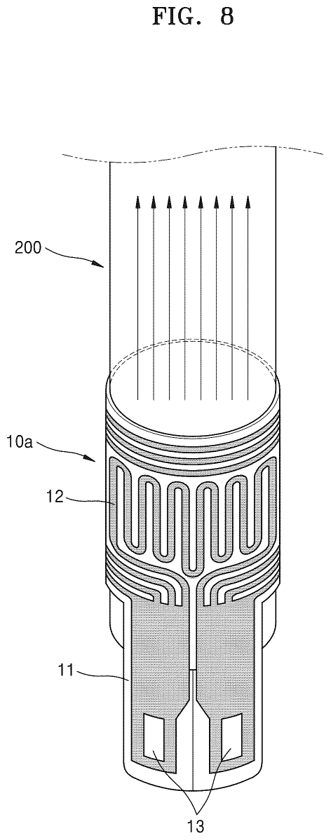

FIG. 8 is a perspective view illustrating the stick heater 10a of the aerosol generating device 100 illustrated in FIG. 7. The stick heater 10 according to one embodiment is described below with reference to FIG. 8.

The stick heater 10a may be similar to the heater 10 described with reference to FIGS. 1 to 5. Therefore, in order to avoid repetitive description, descriptions of a sheet 11, a heating body 12, and an electrode 13 of the stick heater 10a, which overlap the descriptions made with reference to FIGS. 1 to 7, may be omitted.

The sheet 11, which is flexible and has a thin-film shape, may be bent. The heating body 12 on the sheet 11 may also be bent. That is, the stick heater 10a may be bent as a whole. The sheet 11 may have a curved surface. A space for heating may be formed inside the sheet 11.

At least a part of the aerosol generating article 200 may be accommodated inside the curved surface of the sheet 11. The stick heater 10a may transfer heat to the aerosol generating article 200. For example, the sheet 11 may receive heat from the heating body 12 and transfer the heat to the aerosol generating article 200. The stick heater 10a bent in a curved shape may surround at least a part of an outer surface of the aerosol generating article 200 and heat the outside of the aerosol generating article 200. The heated aerosol generating article 200 may generate an aerosol. In FIG. 8, a direction in which an aerosol is generated from the aerosol generating article 200 by the stick heater 10a is illustrated by several arrows. However, this is only an example, and the aerosol generation direction is not limited thereto.

According to resistance temperature coefficient characteristics of the heating body 12, the internal resistance may increase as the temperature increases. For example, the temperature and resistance of the heating body 12 may be proportional to each other in a preset temperature range. That is, the heating body 12 may be a type of variable resistor of which resistance changes according to the temperature. Therefore, the heating body 12 may function as a temperature sensor that provides information on temperature.

For example, a preset voltage may be applied to the heating body 12, and a current flowing through the heating body 12 may be measured by a current sensor. Also, the resistance of the heating body 12 may be calculated through a ratio of the measured current to the applied voltage. Based on the calculated resistance, the temperature of the heating body 12 or the sheet 11 may be estimated according to the resistance temperature coefficient characteristics of the heating body 12.

The heating body 12 may include a first heating wire and a second heating wire. According to the present disclosure, either the first heating wire or the second heating wire may be used as a temperature sensor. For example, when the sheet 11 is heated by the first heating wire, the second heating wire may be used as a temperature sensor. In another example, when the sheet 11 is heated by the second heating wire, the first heating wire may be used as a temperature sensor. A controller may calculate information on the temperature based on a current flowing through the first heating wire and/or the second heating wire. The controller may control all operations of the aerosol generating device according to the information on temperature.

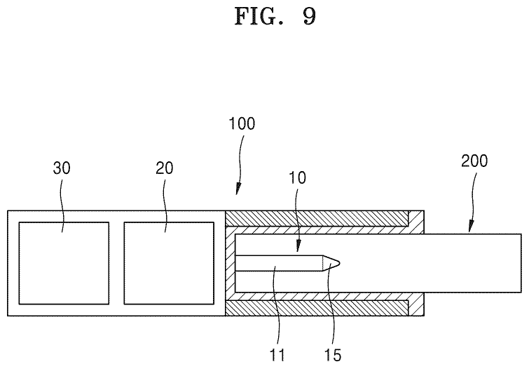

FIG. 9 is a configuration diagram illustrating an aerosol generating device according to another embodiment of the present disclosure. The aerosol generating device according to another embodiment is described below with reference to FIG. 9.

In order to avoid repetitive description, the description of an aerosol generating device 100, which overlaps the description made with reference to FIG. 6, may be omitted.

The aerosol generating device 100 may include a heater 10, a power supply 20, and a controller 30. The heater 10 may be the heater 10 described above with reference to FIGS. 1 to 5 but is not limited thereto. The power supply 20 may supply power to components of the aerosol generating device 100, such as the heater 10. The controller 30 may control operations of components of the aerosol generating device 100, such as the heater 10 and the power supply 20.

An aerosol generating article 200 may be detachably coupled to the aerosol generating device 100. The aerosol generating article 200 may include an aerosol generating material, and when the aerosol generating material is heated by the heater 10, an aerosol may be generated.

The heater 10 may be electrically connected to the power supply 20. The heater 10 may receive power from the power supply 20. As a current flows through the heater 10, the temperature of the aerosol generating article 200 may increase, and accordingly, an aerosol may be generated.

The heater 10 may include a heating unit 15. The heating unit 15 may include a base portion and a needle tip portion. For example, the base portion of the heating unit 15 may be formed in a cylindrical shape, and the needle tip portion may be formed in a cone shape, but the present disclosure is not limited thereto. Also, the needle tip portion of the heating unit 15 may be formed at one end of the base portion to be easily inserted into the aerosol generating article 200. In this case, the base portion and the needle tip portion may be formed as one body. Alternatively, the base portion and the needle tip portion may be manufactured separately and then combined with each other.

The heating unit 15 may include a thermal conductive material. For example, the thermal conductive material may include ceramic including alumina or zirconia, anodized metal, coated metal, polyimide (PI), or so on but is not limited thereto.

According to one embodiment, the sheet 11 of the heater 10 may surround at least a part of the heating unit 15. For example, the sheet 11 may surround at least a part of an outer peripheral surface of the base portion of the heating unit 15. The sheet 11 may surround an outer peripheral surface of the heating unit 15 and form a curved surface.

When the aerosol generating article 200 is inserted into the aerosol generating device 100, a part of the aerosol generating article 200 may be outside the curved surface composed of the sheet 11 surrounding the heating unit 15. The sheet 11 may be inserted into at least a part of the inside of the aerosol generating article 200 to heat the inside of the aerosol generating article 200 to generate an aerosol.

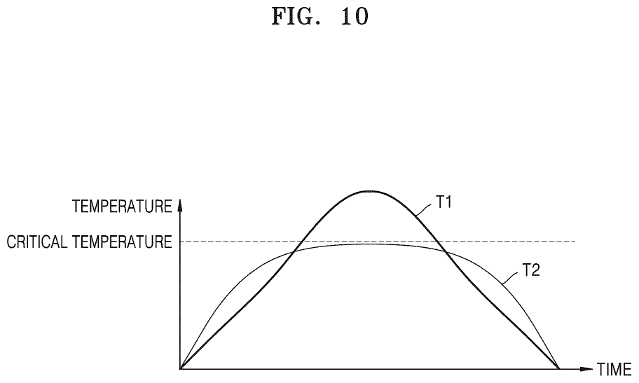

FIG. 10 is a time-temperature graph according to heating of an electroconductive heater according to one embodiment of the present disclosure. The electroconductive heater according to one embodiment is described below with reference to FIG. 10.

The time-temperature graph of FIG. 10 may be a time-temperature graph according to heating of one of the heaters described with reference to FIGS. 1 to 9. The time-temperature graph may be a time-temperature graph according to heating of a certain region of a heating body of one of the heaters described with reference to FIGS. 1 to 9.

A critical temperature refers to the temperature that may cause a problem in durability of a heater.

For example, T1 may be a schematic form of a time-temperature graph according to heating of the heater described with reference to FIG. 1 but is not limited thereto. In addition, T2 may be a schematic form of a time-temperature graph according to heating of any one of the heaters described with reference to FIGS. 2 to 4 but is not limited thereto.

When a schematic form of a time-temperature graph, such as T1, is represented as a heating body is heated, there may be a major problem in the durability of the heater. For example, the critical temperature may be the temperature (a melting point) at which the sheet begins to melt. In another example, the critical temperature may be the temperature at which the sheet begins to burn. in another example, the critical temperature may be the temperature at which a battery begins to overheat.

For example, when the sheet of the heating body is a material that melts at 300° C., the critical temperature may be 300° C.

As experimentally described above with reference to FIG. 5, the first, second, and third embodiments may represent a schematic form of T1, and the fourth embodiment may represent a schematic form of T2. Therefore, when the sheet of the heating body melts at 300° C., the durability of a heater may be increased by using the heater according to the fourth embodiment illustrated in FIG. 4.

in another example, when the sheet of the heating body is a material that melts at 320° C., the critical temperature may be 320° C.

As experimentally described above with reference to FIG. 5, the first and second embodiments may represent the schematic form of T1, and the third and fourth embodiments may represent the schematic form of T2. Therefore, when the sheet of the heating body melts at 320° C., the durability of a heater may be increased by using the heater according to the third embodiment illustrated in FIG. 3 or the heater according to the fourth embodiment illustrated in FIG. 4.

When the same power is applied to the heating body for the same time, the total amount of heat generated when the heating body is heated and shows the schematic form of temperature-time of T1 may be equal to the total amount of heat generated when the heating body is heated and shows the temperature-time reforming of T2. However, the peak temperature of the heating body that is heated and achieves the schematic form of temperature-time of T2 may be lower than the peak temperature of the heating body that is heated and achieves the schematic form of temperature-time of T1. That is, the heating body achieving the schematic form of temperature-time of T2 has an advantage of being able to be heated below a melting point of the sheet while maintaining a calorific value compared to the heating body achieving the schematic form of temperature-time of T1.

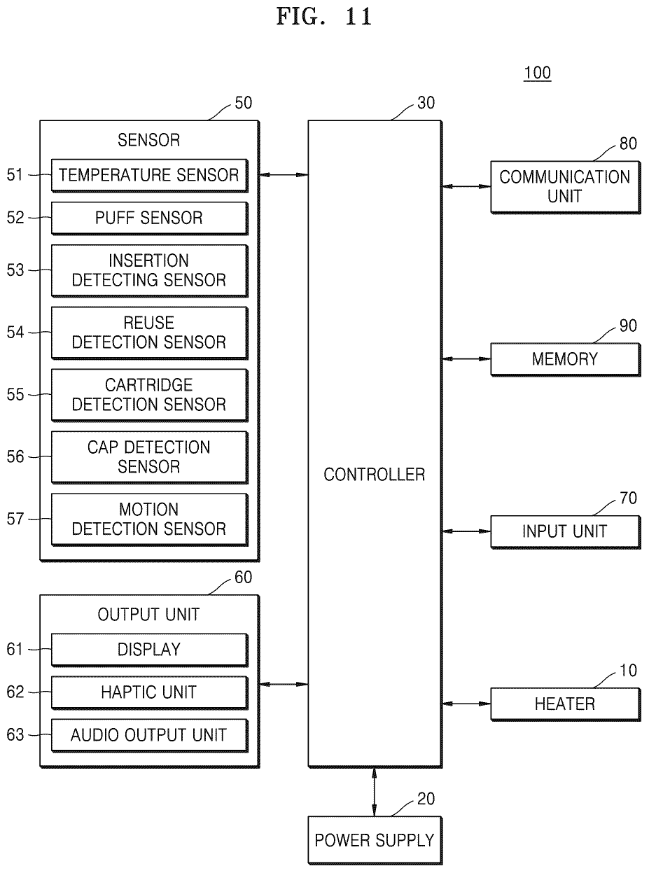

FIG. 11 is a block diagram of an aerosol generating device 100 according to one embodiment of the present disclosure.

The aerosol generating device 100 may include a heater 10, a power supply 20, a controller 30, a sensor 50, an output unit 60, an input unit 70, a communication unit 80, and a memory 90. However, the internal structure of the aerosol generating device 100 is not limited to those illustrated in FIG. 11. That is, according to the design of the aerosol generating device 100, it will be understood by one of ordinary skill in the art that some of the components shown in FIG. 11 may be omitted or new components may be added.

The sensor 50 may sense a state of the aerosol generating device 100 and a state around the aerosol generating device 100, and transmit sensed information to the controller 30. The controller 30 may control the aerosol generating device 100 based on the detected information such that various functions, such as control of an operation of the heater 10, limitation of smoking, determination on whether an aerosol generating article and/or cartridge is inserted, and display of notification are performed.

The sensor 50 may include at least one of a temperature sensor 51, a puff sensor 52, an insertion detecting sensor 53, a reuse detection sensor 54, a cartridge detection sensor 55, a cap detection sensor 56, and a motion detection sensor 57.

The temperature sensor 51 may sense a temperature at which the heater 10 is heated. The aerosol generating device 100 may include a separate temperature sensor for sensing the temperature of the heater 10, or the heater 10 may serve as a temperature sensor.

The temperature sensor 51 may output a signal corresponding to the temperature of the heater 10. For example, the temperature sensor 51 may include a resistance device of which resistance value changes in response to a change in temperature of the heater 10. The resistance device may be implemented by a thermistor or so on which is a device that uses the property of changing resistance according to temperature. In this case, the temperature sensor 51 may output a signal corresponding to a resistance value of the resistance device as a signal corresponding to the temperature of the heater 10. For example, the temperature sensor 51 may include a sensor that detects a resistance value of the heater 10. In this case, the temperature sensor 51 may output a signal corresponding to the resistance value of the heater 10 as a signal corresponding to the temperature of the heater 10.

The temperature sensor 51 may be arranged around the power supply 20 to monitor the temperature of the power supply 20. The temperature sensor 51 may be adjacent to the power supply 20. For example, the temperature sensor 51 may be attached to one side of a battery that serves as the power supply 20. For example, the temperature sensor 51 may be mounted on one side of a printed circuit board.

The temperature sensor 51 may be inside a body to detect the internal temperature of the body.

The puff sensor 52 may detect a user's puff based on various physical changes in an airflow path. The puff sensor 52 may output a signal corresponding to the puff. For example, the puff sensor 52 may be a pressure sensor. The puff sensor 52 may output a signal corresponding to an internal pressure of the aerosol generating device 100. Here, the internal pressure of the aerosol generating device 100 may correspond to the pressure of the airflow path through which a gas flows. The puff sensor 52 may be arranged in the aerosol generating device 100 in response to the airflow path through which a gas flows.

The insertion detecting sensor 53 may detect insertion and/or removal of an aerosol generating article. The insertion detecting sensor 53 may detect a signal change when the aerosol generating article is inserted and/or removed. The insertion detecting sensor 53 may be installed around an insertion space. The insertion detecting sensor 53 may detect the insertion and/or removal of the aerosol generating article according to a change in dielectric constant in the insertion space. For example, the insertion detecting sensor 53 may include an inductive sensor and/or a capacitance sensor.

The inductive sensor may include at least one coil. The at least one coil of the inductive sensor may be adjacent to the insertion space. For example, when a magnetic field changes around the coil through which a current flows, characteristics of the current flowing through the coil may change according to the Faraday's law. Here, the characteristics of the current flowing through the coil may include a frequency, a current value, a voltage value, an inductance value, an impedance value, and so on of an alternating current (an AC current).

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be adjacent to the insertion space. The capacitance sensor may output a signal corresponding to surrounding electromagnetic characteristics, for example, capacitance around the conductor. For example, when an aerosol generating article including a wrapper made of a metal material is inserted into the insertion space, the electromagnetic properties around the conductor may be changed by the wrapper of the aerosol generating article.

The reuse detection sensor 54 may detect whether the aerosol generating article is reused. The reuse detection sensor 54 may be a color sensor. The color sensor may detect a color of the aerosol generating article. The color sensor may detect the color of a part of the wrapper surrounding the exterior of the aerosol generating article. The color sensor may detect values for optical properties corresponding to the color of an object based on the light reflected from the object. For example, the optical properties may be a wavelength of light. The color sensor may be implemented by one component with a proximity sensor or may be implemented by a separate component from the proximity sensor.

At least a part of the wrapper included in the aerosol generating article may be changed in color by an aerosol. When an aerosol generating article is inserted into the insertion space, the reuse detection sensor 54 may be arranged to correspond to a position where at least a part of the wrapper of which color changes due to an aerosol is arranged. For example, before the aerosol generating article is reused by a user, the color of at least a part of the wrapper may be the first color. In this case, as at least a part of the wrapper is wet by an aerosol while the aerosol generated by the aerosol generating device 100 passes through the aerosol generating article, a color of at least a part of the wrapper may be changed to the second color. In addition, the color of at least a part of the wrapper may be changed from the first color to the second color and then maintained in the second color.

The cartridge detection sensor 55 may detect the installation and/or removal of a cartridge. The cartridge detection sensor 55 may be implemented by an inductance-based sensor, a capacitance-type sensor, a resistance sensor, a Hall sensor (Hall IC) using the Hall effect, or so on.

The cap detection sensor 56 may detect the installation and/or removal of a cap. When the cap is separated from a body, a part of the cartridge and body covered by the cap may be exposed to the outside. The cap detection sensor 56 may be implemented by a contact sensor, a Hall sensor (hall IC), an optical sensor, or so on.

The motion detection sensor 57 may detect movement of the aerosol generating device 100. The motion detection sensor 57 may be implemented by at least one of an acceleration sensor and a gyro sensor.

In addition to the sensors described above, the sensor 50 may further include at least one of a humidity sensor, an atmospheric pressure sensor, a magnetic sensor, a position sensor (a global positioning system (GPS)), and a proximity sensor. Because functions of respective sensors may be intuitively deduced by a person skilled in the art from names thereof, detailed descriptions thereof may be omitted.

The output unit 60 may output information on a state of the aerosol generating device 100 and provide the information to a user. The output unit 60 may include at least one of a display 61, a haptic unit 62, and a sound output unit 63, but is not limited thereto. When the display 61 and a touch pad form a layered structure to form a touch screen, the display 61 may also be used as an input device in addition to an output device.

The display 61 may visually provide information about the aerosol generating device 100 to the user. For example, information about the aerosol generating device 100 may mean various pieces of information, such as a charging/discharging state of the power supply 20 of the aerosol generating device 100, a preheating state of the heater 10, an insertion/removal state of an aerosol generating article, or a state in which the use of the aerosol generating device 100 is restricted (e.g., sensing of an abnormal object), or the like, and the display 61 may output the information to the outside. For example, the display 61 may include a light emitting device (LED). For example, the display 61 may include a liquid crystal display panel (LCD), an organic light emitting display panel (OLED), or so on.

The haptic unit 62 may tactilely provide information about the aerosol generating device 100 to the user by converting an electrical signal into a mechanical stimulus or an electrical stimulus. For example, when initial power is supplied to the heater 10 for a set time, the haptic unit 62 may generate vibration corresponding to completion of initial preheating. The haptic unit 62 may include a motor, a piezoelectric element, or an electrical stimulation device.

The sound output unit 63 may audibly provide information about the aerosol generating device 100 to the user. For example, the sound output unit 63 may convert an electrical signal into a sound signal and output the same to the outside.

The power supply 20 may supply power used for operating the aerosol generating device 100. The power supply 20 may supply power to heat the heater 10. In addition, the power supply 20 may supply power required for operations of the sensor 50, the output unit 60, the input unit 70, the communication unit 80, and the memory 90 which are other components provided in the aerosol generating device 100. The power supply 20 may include a rechargeable battery or a disposable battery. For example, the power supply 20 may include a lithium polymer (LiPoly) battery but is not limited thereto.

Although not illustrated in FIG. 11, the aerosol generating device 100 may further include a power protection circuit. The power protection circuit is electrically connected to the power supply 20 and may include a switching element.

The power protection circuit may block an electric path for the power supply 20 according to a preset condition. For example, the power protection circuit may block the electric path for the power supply 20 when a voltage level of the power supply 20 is higher than or equal to the first voltage corresponding to overcharging. For example, the power protection circuit may block the electric path for the power supply 20 when the voltage level of the power supply 20 is lower than the second voltage corresponding to overdischarging.

The heater 10 may receive power from the power supply 20 and heat a medium or aerosol generating material in an aerosol generating article. Although not illustrated in FIG. 11, the aerosol generating device 100 may further include a power conversion circuit (for example, a direct current (DC)/DC converter) that converts the power of the power supply 20 and supplies the converted power to the heater 10. Also, when the aerosol generating device 100 generates an aerosol by using an induction heating method, the aerosol generating device 100 may further include a DC/AC converter that converts DC power of the power supply 20 into AC power.

The controller 30, the sensor 50, the output unit 60, the input unit 70, the communication unit 80, and the memory 90 may perform their functions by receiving power from the power supply 20. Although not illustrated in FIG. 11, the aerosol generating device 100 may further include a power conversion circuit that converts the power of the power supply 20 and supplies the converted power to respective components, for example, a low dropout (LDO) circuit or a voltage regulator circuit. Also, although not illustrated in FIG. 11, a noise filter may be provided between the power supply 20 and the heater 10. The noise filter may include a low pass filter. The low pass filter may include at least one inductor and at least one capacitor. A cutoff frequency of the low pass filter may correspond to a frequency of a high-frequency switching current applied from the power supply 20 to the heater 10. The low pass filter may prevent high-frequency noise components from being applied to the sensor 50, such as the insertion detecting sensor 53.

In an embodiment, the heater 10 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 10 may be implemented by a metal wire, a metal plate on which an electrically conductive track is arranged, or a ceramic susceptor, but is not limited thereto.

The input unit 70 may receive information input from the user or may output information to the user. For example, the input unit 70 may include a touch panel. The touch panel may include at least one touch sensor that detects touch. For example, the touch sensor may include a capacitive touch sensor, a resistive touch sensor, a surface acoustic wave touch sensor, an infrared touch sensor, or so on but is not limited thereto.

The display 61 and the touch panel may be implemented as one panel. For example, the touch panel may be inserted into the display 61 (on-cell type or in-cell type). For example, the touch panel may be an add-on type on the display 61 panel.

In addition, the input unit 70 may include a button, a keypad, a dome switch, a jog wheel, a jog switch, and/or so on but is not limited thereto.

The memory 90 is a hardware component that stores various types of data processed in the aerosol generating device 100, and may store data processed and data to be processed by the controller 30. The memory 90 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 90 may store an operation time of the aerosol generating device 100, the maximum number of puffs, the current number of puffs, at least one temperature profile, data on a user's smoking pattern, etc.

The communication unit 80 may include at least one component for communication with another electronic device. For example, the communication unit 80 may include a short-range wireless communication unit and a wireless communication unit.

The short-range wireless communication unit may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, or the like, but is not limited thereto.

The wireless communication unit may include a cellular network communication unit, an Internet communication unit, a computer network (e.g., local area network (LAN) or wide area network (WAN)) communication unit, or the like, but is not limited thereto.

Although not illustrated in FIG. 11, the aerosol generating device 100 may further include a connection interface, such as a Universal Serial Bus (USB) interface and may be connected to another external device through a connection interface, such as a USB interface to transmit and receive information or charge the power supply 20.

The controller 30 may control the overall operation of the aerosol generating device 100. In an embodiment, the controller 30 may include at least one processor. The processor may be implemented as an array of a plurality of logic gates, or may be implemented as a combination of a general-purpose microprocessor and a memory in which a program executable by the microprocessor is stored. It will be understood by one of ordinary skill in the art that the processor may be implemented in other forms of hardware.

The controller 30 may control the temperature of the heater 10 by controlling the supply of power from the power supply 20 to the heater 10. The controller 30 may control the temperature of the heater 10 based on the temperature of the heater 10 detected by the temperature sensor 51. The controller 30 may adjust the power supplied to the heater 10 based on the temperature of the heater 10. For example, the controller 30 may determine a target temperature for the heater 10 based on a temperature profile stored in the memory 90.

The aerosol generating device 1000 may include a power supply circuit (not illustrated) that is between the power supply 20 and the heater 10 and electrically connected to the power supply 20. The power supply circuit may be electrically connected to the heater 10. The power supply circuit may include at least one switching element. The switching element may be implemented by a bipolar junction transistor (BJT), a field effect transistor (FET), or so on. The controller 30 may control the power supply circuit.

The controller 30 may control power supply by controlling the switching of the switching element of the power supply circuit. The power supply circuit may include an inverter that converts DC power output from the power supply 20 into AC power. For example, the inverter may be configured as a full-bridge circuit or a half-bridge circuit including a plurality of switching elements.

The controller 30 may turn on the switching element such that power is supplied from the power supply 20 to the heater 10. The controller 30 may turn off the switching element such that supplying power to the heater 10 is cut off. The controller 30 may adjust a current supplied from the power supply 20 by adjusting a frequency and/or duty ratio of a current pulse input to the switching element.

The controller 30 may control a voltage output from the power supply 20 by controlling the switching of the switching element of the power supply circuit. A power conversion circuit may convert a voltage output from the power supply 20. For example, the power conversion circuit may include a buck converter that decreases the voltage output from the power supply 20. For example, the power conversion circuit may be implemented by a buck-boost converter, a Zener diode, or so on.

The controller 30 may adjust a level of a voltage output from the power conversion circuit by controlling an on/off operation of a switching element included in the power conversion circuit. When the switching element is continuously in an on state, the level of the voltage output from the power conversion circuit may correspond to a level of a voltage output from the power supply 20. A duty ratio of the on/off operation of the switching element may correspond to a ratio of the voltage output from the power conversion circuit to the voltage output from the power supply 20. As the duty ratio for the on/off operation of the switching element decreases, the level of the voltage output from the power conversion circuit may decrease. The heater 10 may be heated based on the voltage output from the power conversion circuit.

The controller 30 may control power by using at least one of a pulse width modulation (PWM) method and a proportional-integral-differential (PID) method such that the power is supplied to the heater 10.

For example, the controller 30 may control a current pulse having a preset frequency and duty ratio by using the PWM method such that the current pulse is supplied to the heater 10. The controller 30 may control the power supplied to the heater 10 by adjusting a frequency and duty ratio of the current pulse.

For example, the controller 30 may determine a target temperature that is a target of control based on a temperature profile. The controller 30 may control the power supplied to the heater 10 by uses a PID method which is a feedback control method using a difference value between the temperature of the heater 10 and the target temperature, a value obtained by integrating the difference value over time, and a value obtained by differentiating the difference value over time.

The controller 30 may prevent the heater 10 from overheating. For example, the controller 30 may control an operation of the power conversion circuit based on the temperature of the heater 10 exceeding a preset temperature limit such that the supply of power to the heater 10 is stopped. For example, the controller 30 may reduce the amount of power supplied to the heater 10 by a certain ratio based on the temperature of the heater 10 exceeding a preset limit temperature. For example, the controller 30 may determine that an aerosol generating material included in a cartridge is exhausted based on the temperature of the heater 10 exceeding a limit temperature and may block the power supply to the heater 10.

The controller 30 may control charging and discharging of the power supply 20. The controller 30 may check the temperature of the power supply 20 based on an output signal of the temperature sensor 51.

When a power line is connected to a battery terminal of the aerosol generating device 1000, the controller 30 may check whether the temperature of the power supply 20 is higher than or equal to the first limit temperature which is a criterion for blocking charging of the power supply 20. The controller 30 may control charging of the power supply 20 based on a preset charging current when the temperature of the power supply 20 is below the first limit temperature. The controller 30 may block charging of the power supply 20 when the temperature of the power supply 20 is higher than or equal to the first limit temperature.

When power is supplied to the aerosol generating device 1000, the controller 30 may check whether the temperature of the power supply 20 is higher than or equal to the second limit temperature which is a criterion for blocking discharging of the power supply 20. The controller 30 may control the power stored in the power supply 20 such that the power is used when the temperature of the power supply 20 is lower than the second limit temperature. The controller 30 may stop the use of the power stored in the power supply 20 when the temperature of the power supply 20 is higher than or equal to the second limit temperature.

The controller 30 may calculate the remaining capacity of the power stored in the power supply 20. For example, the controller 30 may calculate the remaining capacity of the power supply 20 based on the detected voltage value and/or current value of the power supply 20.

The controller 30 may determine whether an aerosol generating article is inserted into an insertion space through the insertion detecting sensor 53. The controller 30 may determine that an aerosol generating article is inserted based on an output signal of the insertion detecting sensor 53. When it is determined that an aerosol generating article is inserted into the insertion space, the controller 30 may control power such that the power is supplied to the heater 10. For example, the controller 30 may supply power to the heater 10 based on a temperature profile stored in the memory 90.

The controller 30 may determine whether the aerosol generating article is removed from the insertion space. For example, the controller 30 may determine whether the aerosol generating article is removed from the insertion space through the insertion detecting sensor 53. For example, the controller 30 may determine that the aerosol generating article is removed from the insertion space when the temperature of the heater 10 is greater than or equal to a limit temperature or when a temperature change slope of the heater 10 is greater than or equal to a preset slope. When it is determined that the aerosol generating article is removed from the insertion space, the controller 30 may block the supply of power to the heater 10.

The controller 30 may control the power supply time and/or power supply amount to the heater 10 according to a state of an aerosol generating article detected by the sensor 50. The controller 30 may check a level range including a level of a signal of the capacitance sensor based on a lookup table. The controller 30 may determine a moisture amount of the aerosol generating article according to the checked level range.

When the aerosol generating article is in an overhumidity state, the controller 30 may control the power supply time to the heater 10 to increase a preheating time of the aerosol generating article compared to a case in a general state.

The controller 30 may determine whether the aerosol generating article inserted into the insertion space is reused through the reuse detection sensor 54. For example, the controller 30 may compare a sensing value of a signal from the reuse detection sensor with the first reference range including the first color, and when the sensing value is included in the first reference range, the controller 30 may determine that the aerosol generating article is not used. For example, the controller 30 may compare the sensing value of the signal from the reuse detection sensor with the second reference range including the second color, and when the sensing value is included in the second reference range, the controller 30 may determine that the aerosol generating article is used. When it is determined that the aerosol generating article is used, the controller 30 may block the supply of power to the heater 10.

The controller 30 may determine whether a cartridge is coupled and/or removed through the cartridge detection sensor 55. For example, the controller 30 may determine whether the cartridge is coupled or removed based on the detected value of the signal from the cartridge detection sensor.

The controller 30 may determine whether the aerosol generating material in the cartridge is exhausted. For example, the controller 30 may apply power to preheat the heater 10 and determine whether the temperature of the heater 10 exceeds the limit temperature in a preheating section, and when the temperature of the heater 10 exceeds the limit temperature, the controller 30 may determine that the aerosol generating material in the cartridge is exhausted. When it is determined that the aerosol generating material in the cartridge is exhausted, the controller 30 may block the supply of power to the heater 10.

The controller 30 may determine whether the cartridge may be used. For example, when the current number of puffs is greater than or equal to the greatest number of puffs set to the cartridge based on the data stored in the memory 90, the controller 30 may determine that the cartridge may not be used. For example, when the total time for which the heater 10 is heated is greater than or equal to a preset greatest time or the total amount of power supplied to the heater 10 is greater than or equal to a preset greatest amount of power, the controller 30 may determine that the cartridge may not be used.

The controller 30 may determine a user's inhalation through the puff sensor 52. For example, the controller 30 may determine whether a puff is generated based on a detected value of a signal from the puff sensor. For example, the controller 30 may determine the intensity of puff based on the detected value of the signal from the puff sensor 52. When the number of puffs reaches the preset greatest number of puffs or when no puff is detected for a preset time or more, the controller 30 may block the supply of power to the heater 10.

The controller 30 may determine whether a cap is coupled and/or removed through the cap detection sensor 56. For example, the controller 30 may determine whether the cap is coupled and/or removed based on the detected value of a signal from the cap detection sensor.

The controller 30 may control the output unit 60 based on a result detected by the sensor 50. For example, when the number of puffs counted by the puff sensor 52 reaches a preset number, the controller 30 may notify a user that the aerosol generating device 1000 is going to be shut down soon, through at least one of the display 61, a haptic unit 62, and an audio output unit 63. For example, the controller 30 may notify a user through the output unit 60 based on the determination that there is no aerosol generating article in the insertion space. For example, the controller 30 may notify a user through the output unit 60 based on a determination that at least one of the cartridge and the cap is not mounted. For example, the controller 30 may transmit information on the temperature of the heater 10 to a user through the output unit 60.

The controller 30 may store and update the history of an event occurring in the memory 90 based on the occurrence of a preset event. The event may include detection of insertion of an aerosol generating article, initiation of heating of the aerosol generating article, detection of a puff, termination of a puff, detection of overheating of the heater 10, detection of application of an overvoltage to the heater 10, termination of heating of the aerosol generating article, an operation of turning on or off of power of the aerosol generating device 1000, initiation of charging of the power supply 20, detection of overcharging of the power supply 20, termination of charging of the power supply 20, and so on, which are performed by the aerosol generating device 1000. The history of the event may include the date and time when the event occurs, log data corresponding to the event, and so on. For example, when a preset event is detection of insertion of an aerosol generating article, log data corresponding to the event may include data on a detected value of the insertion detecting sensor 53 and so on. For example, when a preset event is detection of overheating of the heater 10, the log data corresponding to the event may include data on the temperature of the heater 10, a voltage applied to the heater 10, a current flowing through the heater 10, and so on.

The controller 30 may cause a communication link to be formed with an external device, such as a user's mobile terminal. When receiving data on authentication from the external device through the communication link, the controller 30 may release the restriction on the use of at least one function of the aerosol generating device 1000. Here, the data on authentication may include data indicating completion of user authentication for a user corresponding to an external device. A user may perform user authentication through an external device. The external device may determine whether the user data is valid based on the user's birthday, a unique number representing the user, and so on and may receive data on permission to use the aerosol generating device 1000 from an external server. The external device may transmit data indicating completion of user authentication to the aerosol generating device 1000 based on the data on use authorization. When the user authentication is completed, the controller 30 may release restrictions on the use of at least one function of the aerosol generating device 1000. For example, when the user authentication is completed, the controller 30 may release restrictions on the use of a heating function for supplying power to the heater 10.

The controller 30 may transmit data on a state of the aerosol generating device 1000 to an external device through the communication link formed with the external device. Based on the received state data, an external device may output the remaining capacity, an operation mode, and so on of the power supply 20 of the aerosol generating device 1000 through the display of the external device.

An external device may transmit a position search request to the aerosol generating device 1000 based on an input for initiating the position search of the aerosol generating device 1000. When receiving the position search request from an external device, the controller 30 may control at least one of output devices to perform an operation corresponding to a position search based on the received position search request. For example, the haptic unit 62 may generate vibration in response to the position search request. For example, the display 61 may output objects corresponding to the position search and search termination in response to the position search request.

When receiving firmware data from an external device, the controller 30 may cause firmware to be updated. An external device may check a current version of the firmware of the aerosol generating device 1000 and determine whether there is a new version of the firmware. When receiving an input requesting firmware download, an external device may receive firmware data of a new version and transmit the firmware data of new version to the aerosol generating device 1000. When receiving the firmware data of new version, the controller 30 may cause the firmware of the aerosol generating device 1000 to be updated.

The controller 30 may transmit data on a detected value of at least one sensor 50 to an external server (not illustrated) through the communication unit 80 and receive a learning model generated by learning the detected value through machine learning, such as deep learning, from the server and store the learning model. The controller 30 may perform an operation of determining a user's inhalation pattern, an operation of generating a temperature profile, and so on by using the learning model received from the server. The controller 30 may store, in the memory 90, data of a detected value of at least one sensor 50, data for learning an artificial neural network (ANN), and so on. For example, the memory 90 may store a database for each configuration provided in the aerosol generating device 1000, weights constituting an ANN structure, and bias to learn the ANN. The controller 30 may generate at least one learning model used for determination of a user's inhalation pattern, generation of a temperature profile, and so on by learning data on a detected value of at least one sensor 50, the user's inhalation pattern, the temperature profile, and so on, which are stored in the memory 90.

Any or other embodiments of the present disclosure described above are not exclusive or distinct from each other. In certain embodiments or other embodiments of the present disclosure described above, respective configurations or functions may be used in combination or combined with each other.

For example, a configuration A described in a particular embodiment and/or drawing may be combined with a configuration B described in another embodiment and/or drawing. That is, even when a combination between components is not directly described, any combination may be made except a case where it is described that the combination may not be made.

The description made above should not be construed as restrictive in any respect and should be considered illustrative. The scope of the present disclosure should be determined by reasonable interpretation of the appended claims, and all changes within the equivalent scope of the present disclosure are included in the scope of the present disclosure.

A heater and the aerosol generating device including the heater according to various embodiments of the present disclosure may provide a shape of a heating body that may form a uniform heat distribution, and thus, the power consumption efficiency and heat generation efficiency of a heater may be increased.

The heater and the aerosol generating device including the heater according to various embodiments of the present disclosure may provide a shape of a heating body that may prevent a heat generation bottleneck and an electronic bottleneck, and thus, overheating may be prevented, and the durability of the heater may be increased.

Effects of the embodiments are not limited to the effects described above, and effects not described may be clearly understood by those skilled in the art from the present disclosure and the attached drawings.

What is claimed is:

1. A heater comprising:
a sheet including a heating region, having of a thin-film shape, and being flexible;
a heating body arranged in the heating region and configured to generate heat by receiving power; and
an electrode electrically connected to the heating body and configured to supply the power to the heating body,
wherein the heating body includes a first heating wire arranged along at least a part of an edge of the heating region and a second heating wire arranged in a region surrounded by the first heating wire.

2. The heater of claim 1, wherein the heating body further includes a curved region where an extension direction changes to form a preset curvature.

3. The heater of claim 1, wherein
the heating region is a rectangle, and
the first heating wire extends to correspond to a boundary of the rectangle of the heating region.

4. The heater of claim 1, wherein at least a part of the second heating wire is separated from at least a part of the first heating wire at regular intervals and extends in a same direction as an extension direction of the first heating wire.

5. The heater of claim 1, wherein the heating body further includes at least one heating wire arranged in a region surrounded by the second heating wire.

6. The heater of claim 1, wherein the heating body further includes a pattern region where an extension direction is regularly changed.

7. The heater of claim 1, wherein
the sheet includes a first sheet of a thin-film shape and a second sheet of a thin-film shape, and
the heater is arranged in a space between the first sheet and the second sheet.

8. The heater of claim 1, further comprising a coating layer applied onto at least a part of the sheet.

9. The heater of claim 1, wherein the sheet has a curved surface and a space therein for heating.

10. The heater of claim 1, further comprising:
a liquid delivery member configured to absorb a liquid,
wherein the sheet is in contact with at least a part of an outer surface of the liquid delivery member.

11. The heater of claim 1, further comprising:
a heating unit including a base portion of a cylindrical shape and a needle tip portion of a cone shape arranged at one end of the base portion,
wherein the sheet surrounds at least a part of an outer peripheral surface of the heating unit.

12. The heater of claim 1, wherein the heater further includes an alloy of copper and nickel.

13. The heater of claim 1, wherein the sheet includes an electrical insulating material.

14. An aerosol generating device comprising:
the heater according to claim 1;
a power supply configured to supply power to the heater; and
a controller configured to control operations of the power supply and the heater.

15. The aerosol generating device of claim 14, wherein the controller is further configured to calculate information on temperature based on a current flowing through one of the first heating wire and the second heating wire.
